(19) United States
(12) Patent Application Publication
(10) Pub. No.: US 2003/0164898 A1
(43) Pub. Date: Sep. 4, 2003

(54) INFORMATION PROCESSING APPARATUS, INFORMATION PROCESSING SYSTEM AND STORAGE MEDIUM

(76) Inventor: KUNIO IMAI, TOKYO (JP)

Correspondence Address: FITZPATRICK CELLA HARPER & SCINTO, 30 ROCKEFELLER PLAZA, NEW YORK, NY, 10112, US

(21) Appl. No.: 09/046,548

(22) Filed: Mar. 24, 1998

(30) Foreign Application Priority Data
Mar. 24, 1997 (JP) 9-070197
Mar. 20, 1998 (JP) 10-071541

(51) Int. Cl. H04N 7/00

(52) U.S. Cl. 348/465; 348/552

(57) ABSTRACT

An object of the present invention is to provide an information processing apparatus which is excellent in operability and can easily and certainly obtain desired information. In the information processing apparatus, in case of extracting data of a program corresponding to a specific field information from among data superimposed on television broadcast, an extraction means 131 searches and extracts by using a keyword the data of the program corresponding to the specific field information from data of a table of contents or data of program contents both included in the superimposed data, obtains a program number and a channel of the program from the extracted data, and automatically sets the obtained program number and channel. A series of processes are performed based on the set program number and channel, and information obtained as a result of the processes, i.e., the data of the program corresponding to the specific field information, is print outputted from an output means 151. Thus, operations to designate the program number and the channel become unnecessary.

### BACKGROUND OF THE INVENTION

1. Field of the Invention

The present invention relates to an information processing apparatus, an information processing system and a storage medium storing information process steps. The apparatus, the system and the storage medium perform such a process as a character broadcast or the like wherein a television signal in which information is superimposed on a vertical retrace line term of an image signal is received, and information of such a broadcast program is print outputted.

2. Related Background Art

Generally, character broadcast is a broadcast system in which information transmitted by utilizing a vertical retrace line term (vertical blanking term) of an image signal not appeared as an image on a display screen in television broadcast is displayed as a still image such as a character, a graphic (i.e., figure) or the like.

Although image broadcast is time-serially sent, the ordinary character broadcast is simultaneously sent, whereby a user can always watch the information sent in the character broadcast if he wish.

The above character broadcast can be utilized free and includes plenty of useful information. However, under the present condition of our country, a rate of the number of receivers having a function (character broadcast reception function) for receiving the character broadcast is extremely low in the prevalence number of television receivers.

One of the reasons thereof is that the character broadcast has not been well known. However, even if the user actually has the receiver having the character broadcast reception function, he has not used this function because an operation to watch the character broadcast is highly complicated and working to stare and read character information on the display screen psychologically burdens him.

Therefore, as one method to solve such a problem, for example, it can be expected to previously reserve a program intended to be watched and then print output the reserved program at a predetermined time.

Thus, once the user performs such a reservation operation, then he may wait for the reserved program to be automatically print outputted. As a result, it can be obtained a condition that the user easily utilizes the character broadcast.

However, even in such the method, the user must perform at least one reservation operation.

That is, it is necessary for the user to select a channel concerning the intended character broadcast program, and also designate a program number of this program. Especially, if the user wishes to watch the plural character broadcast programs, he must perform the reservation operation plural times corresponding to the number of these programs.

Such the reservation operations are highly troublesome for the user. Therefore, if such a problem is not solved, the user may not intend to readily utilize the character broadcast. Further, in such environment, even if the receiver having the character broadcast reception function is widely and generally prevailed, there is some fear that such environment as frequently utilizing the character broadcast does not appear.

Further, in recent years, it has started data broadcast in which, like the character broadcast, the information is superimposed on the vertical retrace line interval of the image signal. In the data broadcast, of course, the same problems as in the character broadcast occur. Also, the same problems occur in a push-type information transmitted through an internet.

### SUMMARY OF THE INVENTION

An object of the present invention is to entirely or individually solve the above-described problems.

An another object of the present invention is to enable a user to easily output desired information from among information transmitted through an internet.

A still another object of the present invention is to provide an information processing apparatus, an information processing system and a storage medium which eliminate the above-described problems, have excellent operability and can easily and certainly obtain desired information.

In order to achieve the above objects, according to a preferred embodiment of the present invention, it is disclosed a system comprising:

a reception means for receiving broadcast of a predetermined system, including data superimposed on a radio wave;

an extraction means for extracting the data superimposed on the broadcast wave received by the reception means;

a judgment means for judging by using a keyword whether or not the data extracted by the extraction means is data of a program corresponding to specific field information; and

an output means for performing a predetermined process on the data extracted by the extraction means and outputting the processed data, on the basis of a judged result of the judgment means.

A still another object of the present invention is to provide a system, especially a print system, which has a new function.

The above and other objects of the present invention will become apparent from the following detailed description when read in conjunction with the accompanying drawings.

### BRIEF DESCRIPTION OF THE DRAWINGS

FIG. 1 is a block diagram showing the structure of a reception apparatus to which an information processing apparatus according to the present invention is applied;

FIG. 2 is a view for explaining character broadcast and data broadcast both received by the reception apparatus;

FIG. 3 is a view for explaining a data format in a horizontal scanning line in the character broadcast and the data broadcast;

FIG. 4 is a view for explaining the format in the character broadcast;

FIG. 5 is a view for explaining a program managing data header and a page data header;

FIG. 6 is a flow chart showing a program setting process;

FIG. 7 is a flow chart showing a process to output information of a set program at a set time;

FIG. 8 is a view showing the structure of a prefixing unit in a data line;

FIG. 9 is a view showing the structure of transmission control data in the data broadcast;

FIG. 10 is a flow chart showing a processing program described in a block diagram of a second embodiment;

FIG. 11 is a block diagram showing a first embodiment;

FIG. 12 is a flow chart showing a processing program described in a block diagram of the first embodiment; and

FIG. 13 is a block diagram showing the second embodiment.

### DETAILED DESCRIPTION OF PREFERRED EMBODIMENT

Hereinafter, one embodiment of the present invention will be explained with reference to the accompanying drawings.

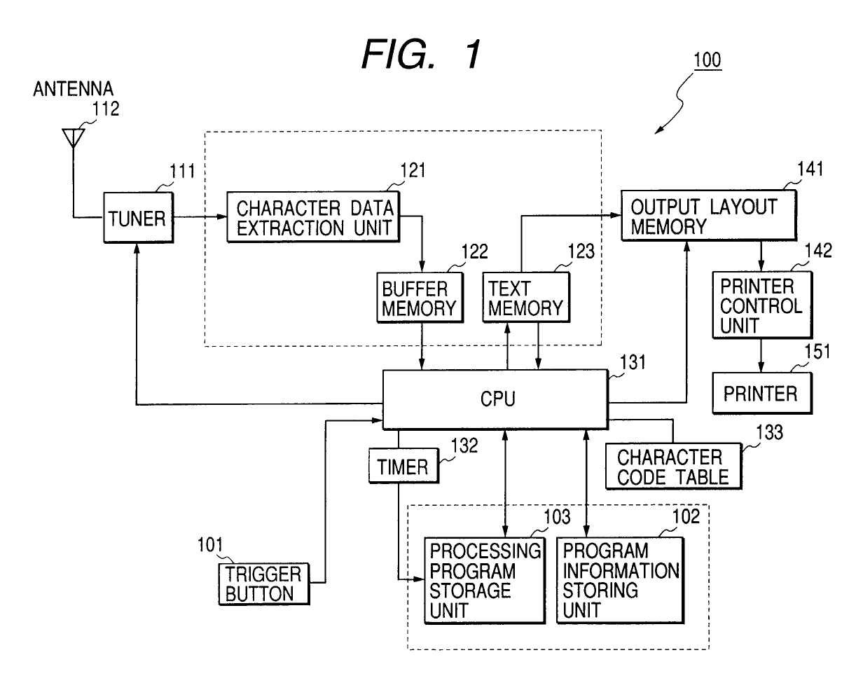

An information processing apparatus according to the present invention is applied to, e.g., a reception apparatus 100 shown in FIG. 1.

The reception apparatus 100 receives a television signal in which information is superimposed on a vertical retrace line term of an image signal in character broadcast, data broadcast or the like. As shown in FIG. 1, the reception apparatus 100 has a character data extraction unit 121 to which a signal received by an antenna 112 is supplied through a tuner 111, and a buffer memory 122 to which an output of the character data extraction unit 121 is supplied.

Further, the reception apparatus 100 has a CPU (Central Processing Unit) 131, and also has a processing program storage unit 103, a program information storage unit 102, a character code table 133, a trigger button 101 and a timer 132 which are all connected to the CPU 131. Thus, an output of the trigger button 101 is supplied to the CPU 131, an output of the timer 132 is supplied to the processing program storage unit 103, and a control signal from the CPU 131 is supplied to the tuner 111.

Furthermore, the reception apparatus 100 has a text memory 123 which is connected to the CPU 131, an output layout memory 141 to which outputs of the CPU 131 and the text memory 123 are supplied, a printer control unit 142 to which an output of the output layout memory 141 is supplied, and a printer 151 to which an output of the printer control unit 142 is supplied.

Initially, the character broadcast and the data broadcast which are received by the above reception apparatus 100 will be explained.

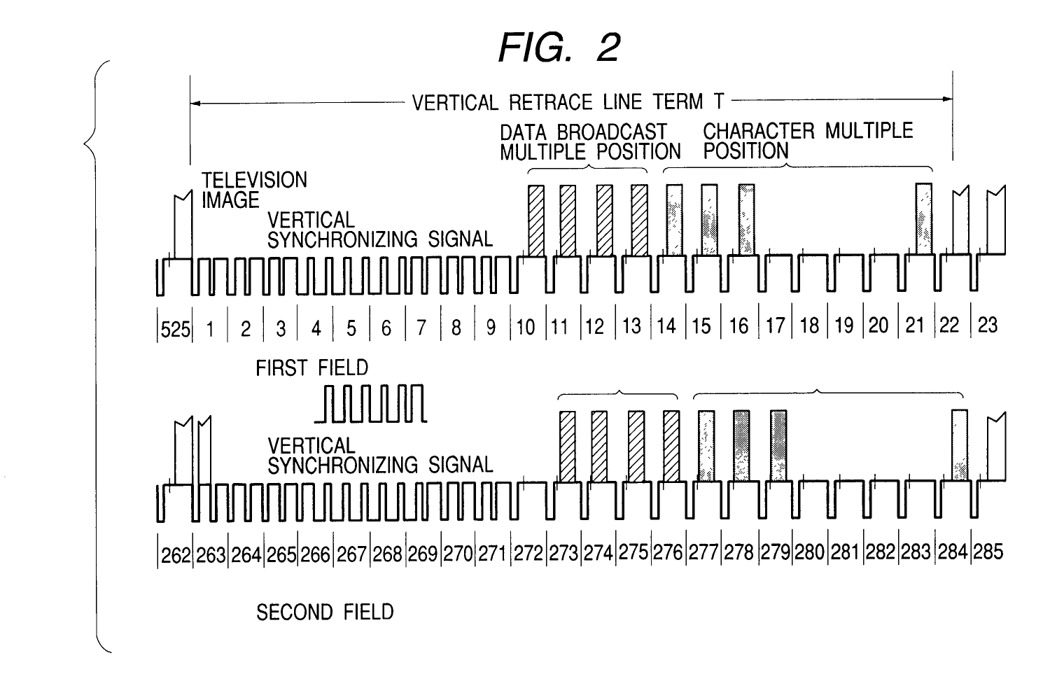

In the character broadcast in our country, as shown in FIG. 2, information is superimposed on four horizontal scanning terms (H) in one field of scanning lines in a vertical blanking term T, and the superimposed information is transmitted.

Namely, in a first field, the character broadcast is allocated to the four horizontal scanning terms, i.e., 14H, 15H, 16H and 21H terms. In a second field, the character broadcast is allocated to the four horizontal scanning terms, i.e., 277H, 278H, 279H and 284H terms.

On the other hand, as recent new data broadcast, it has started in April 1996 such the data broadcast as shown in FIG. 2 in which data is superimposed on the four horizontal scanning terms, i.e., 10H, 11H, 12H and 13H terms in the first field, and is superimposed on the four horizontal scanning terms, i.e., 273H, 274H, 275H and 276H terms in the second field.

Physical conditions of the character broadcast and the data broadcast are identical with each other, and an information quantity to be superimposed is 76 bits (22 bytes) for one horizontal scanning term, except for a synchronizing signal and an error correction signal. Therefore, for one second (60 fields), 1320 (22×60) bytes are used. Such the data is transmitted as not an image but a binary wave height value of “1” or “0” ticked out by a clock for dividing one horizontal period into 364 units, i.e., a clock of 5.72 MHz. Therefore, on a receiver side, predetermined information is extracted from such the data, a frame image is formed such that the extracted information can be watched as a character and a graphic, and the information is actually displayed as a still image.

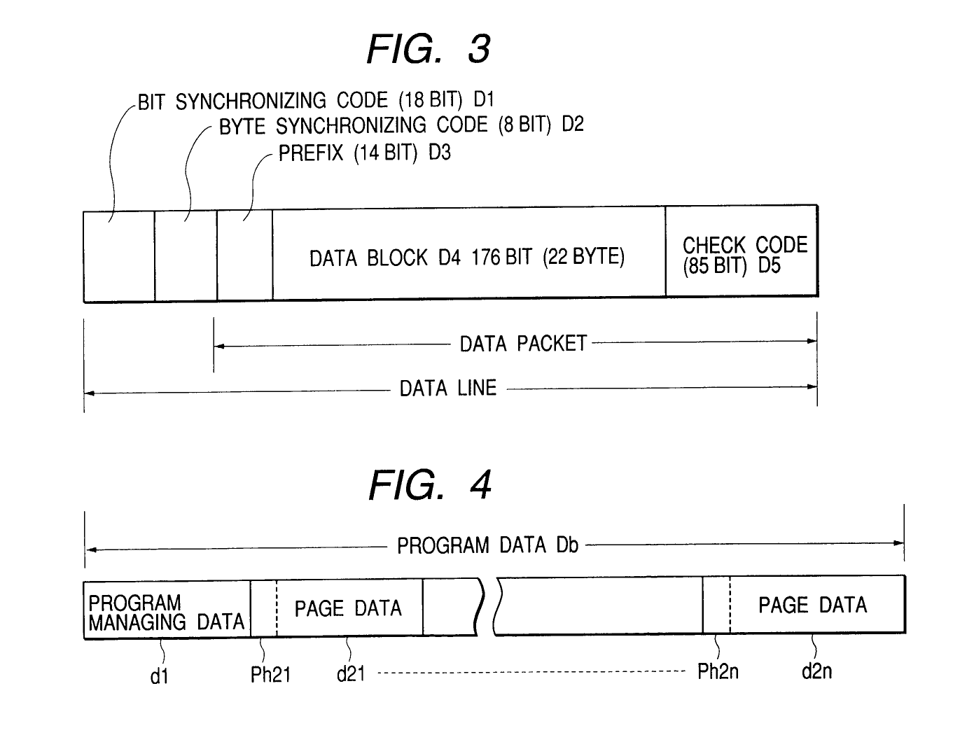

In the data (data line) of one horizontal scanning line, as shown in FIG. 3, a bit synchronizing code D1 of 16 bits is initially added, a byte synchronizing signal D2 of eight bits and a prefixing (or prefix) D3 of 14 bits are subsequently added, a data block D4 of 22 bytes is then added onto the prefixing D3, and a check code D5 of 82 bits is finally added.

The data of 22 bytes in the data block D4 is used as a data block (program data) Db shown in FIG. 4. The data block Db is composed of an initial program managing data header d1 and subsequent page data d21, . . . , d2n. Further, page data headers ph21, . . . , ph2n are added to the respective page data d21, . . . , d2n.

The program managing data header d1 includes information such as the total number of pages of the page data, its data length and the like. Further, each of the page data headers ph21, . . . , ph2n includes information such as a page number of each page and the like.

Therefore, when the character broadcast and the data broadcast are received by the reception apparatus 100, initially the program managing data d1, subsequently the page data header ph21, then the page data d21, . . . , the page data header ph2n, and the page data d2n are sequentially transmitted to the reception apparatus 100.

Subsequently, a series of operations by the reception apparatus 100 to receive the above character broadcast, the data broadcast and the like will be explained.

The program information storage unit 102 is composed of, e.g., a nonvolatile storage device. In this device, broadcast channels and program numbers of programs corresponding to information fields to be outputted and periodic output times have been stored in the program information storage unit 102. For example, this device has stored the information that political, financial and industrial information news or the like are outputted at AM 6:00 and PM 6:00 every day.

Further, in the program information storage unit 102, a correspondence table or the like of the information fields, corresponding search keywords, and the obtained broadcast channels and the program numbers has been stored. Setting of the storage unit 102 is automatically performed at a time when a power source is connected to the apparatus or at a designated time in a manner described later.

On the other hand, when the time stored in the program information storage unit 102 comes, a trigger signal is generated from the CPU 131. Thus, the series of the processing operations such as a reception operation, an information output operation and the like start.

Also, when the trigger button 101 is depressed, the trigger signal is generated from the CPU 131. In other words, when the trigger button 101 is depressed, the similar processing operations start at any time. Therefore, the user can cause the apparatus to output the information not only at the time stored in the program information storage unit 102 but also at an arbitrary time when the information is intended to be outputted.

The CPU 131 is the central processing unit such as a microcomputer or the like. Although the details will be explained later, the CPU 131 controls all operations of the apparatus by executing various processing programs stored in the processing program storage unit 103.

Initially, when the CPU 131 starts the series of the processing operations in response to the depression of the trigger button 101 or the trigger signal generated from the timer 132, under the control of the CPU 131, the tuner 111 is tuned to a broadcast wave received by the antenna 112 to select a predetermined broadcast channel and fetch a television image signal.

The character data extraction unit 121 extracts binary data superimposed on the vertical blanking term of the television image signal fetched by the tuner 111, and holds the extracted binary data in the buffer memory 122.

At this time, the character data extraction unit 121 temporarily holds the binary data included in one horizontal scanning line in the vertical blanking term, in the buffer memory 122.

Although the details will be described later, the CPU 131 judges whether the data held in the buffer memory 122 is the data of the program in the desired information field by using the character code table 133 being a reference table of characters, symbols and the like used in the character broadcast and the data broadcast, information previously stored in the program information storage unit 102 and information later stored in the storage unit 102.

Then, if the data stored in the buffer memory 122 is the data of the program in the desired information field, the CPU 131 stores such the data as text data in the text memory 123.

Further, the CPU 131 performs a layout process to print the text data stored in the text memory 123 onto an output paper, and stores obtained data in the output layout memory 141.

The printer control unit 142 controls an operation of the printer 151 such that the data stored in the output layout memory 141 is printed onto the output paper.

The above-described operations are the series of the operations by the reception apparatus 100. As above, there is no need for the user to designate the broadcast channel and the program number. That is, the reception apparatus 100 itself contains the processing function to form the correspondence table of the information fields and the program numbers. Therefore, the user designates an output field by using a button or the like provided on the apparatus mainbody and corresponding to the information field. Also, the user pre-sets an output field in case of no designation.

Subsequently, the CPU 131 will be concretely explained.

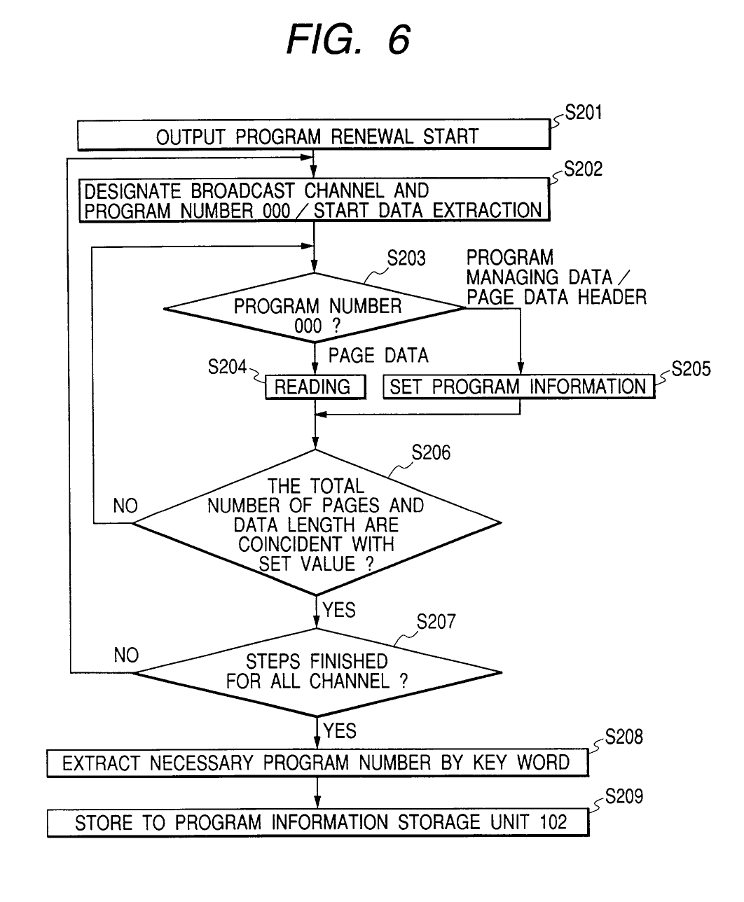

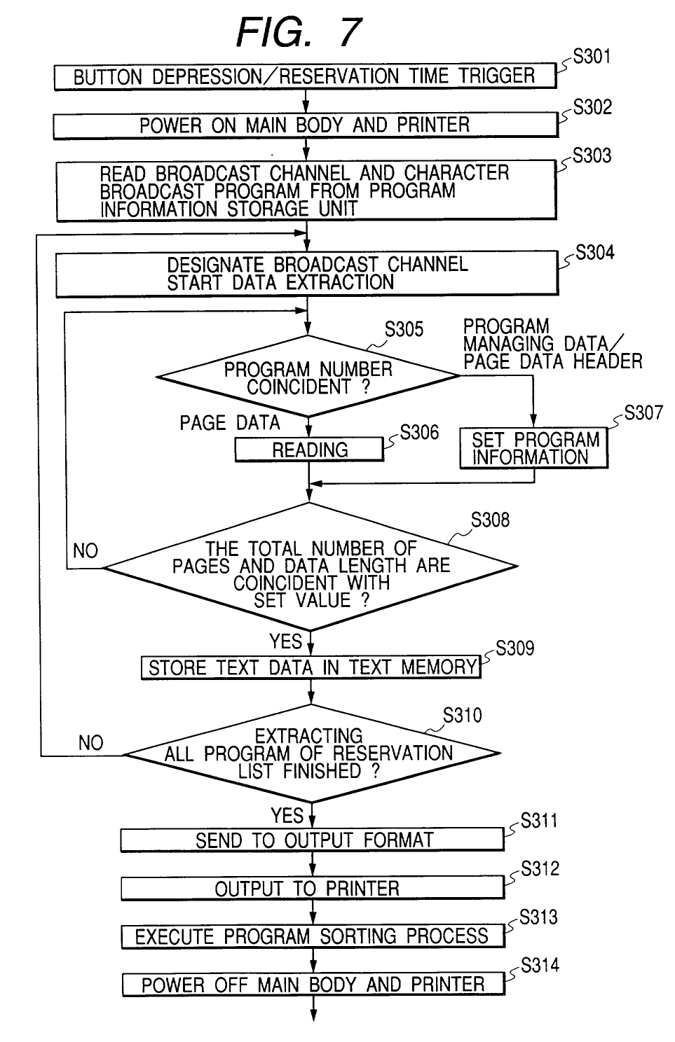

The processing program storage unit 103 is composed of, e.g., a nonvolatile storage device. In the processing program storage unit 103, a main program has been stored and also various processing programs such as a processing program according to flow charts shown in FIGS. 6 and 7 have been stored. These programs are executed by the CPU 131.

It should be noted that the storage medium according to the present invention is applied to the processing program storage unit 103 which stores therein the processing programs according to the flow charts shown in FIGS. 6 and 7.

Initially, a process to search the corresponding broadcast program in the designated information field will be explained with reference to FIG. 6.

Initially, the CPU 131 reads out channel information previously set in the program information storage unit 102 (step S201). The channel information represents the channel through which the character broadcast is performed.

Then, the CPU 131 designates the channel represented by the channel information read out of the program information storage unit 102, to the tuner 111 (step S202).

By the process in the step S202, the designated broadcast channel is selected by the tuner 111, the data superimposed on the vertical blanking term of the selected channel is extracted by the character data extraction unit 121, and the extracted data is held in the buffer memory 122.

In the character broadcast of our country, although a page number indicating list of contents of program (program contents) has been determined to have “000” in any broadcasting station, the present invention is not limited to this determination.

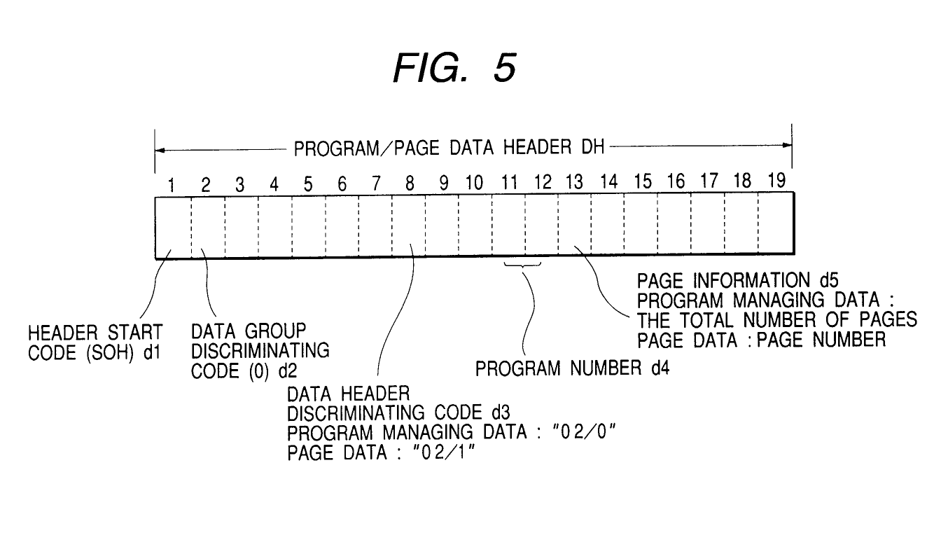

Therefore, in order to obtain the data of the page of the table of contents (i.e., contents data) of the current channel from the data held in the buffer memory 122 (i.e., data for each one horizontal scanning line), the CPU 131 refers to the program managing data shown in FIG. 5 or the data of the program number 000 at a header of page data.

Although the explanation is late, FIG. 5 shows each bit arrangement of the program managing data or the page data both shown in FIG. 4. For example, a data header discriminating code d3 in FIG. 5 is “02/0” when the data is the program managing data, and is “02/1” when the data is the page data.

That is, as described above, the data has a header start code d1 (SOH) at its leading first byte, and the data header discriminating code d3 at its ninth byte. Therefore, if the data header discriminating code d3 is “02/0”, the data is judged to have the header of the program managing data, while if the code d3 is “02/1”, the data is judged to have the header of the page data (step S203).

As a result of the judgment in the step S203, if the data has the program managing data header or the page data header, the CPU 131 sets to a not-shown internal memory the information such as the total page number, the data length and the like included in the data, or the page number (step S205).

On the other hand, as a result of the judgment in the step S203, if the data is the page data, the judged data is stored in the text memory 123. Also, page information d5 (i.e., page number) shown in FIG. 5 and included in the header of the judged data is once stored in the internal memory (not shown in FIG. 1), e.g., an internal cache memory of the CPU 131 (step S204).

The page data (i.e., text or body) extracted in the step S204 (e.g., page data d2n shown in FIG. 4) begins from the data line which is sent subsequently to the page data header ph2n and has a leading data block STX (“00/2”), and terminates with the data line which has a trailing or ending data block ETX (“00/3”), ETB (“01/7”) or EOT (“00/4”).

After the process in the step S204 or S205 terminated, the CPU 131 judges whether or not the total number of the pages set in the step S205 is coincident with the page number stored in the step S204 (step S206).

As a result of the judgment in the step S206, if not coincident, the flow returns to the step S203 and thus the CPU 131 performs the following processes. On the other hand, if coincident, the flow advances to a next step S207.

In the step S207, the CPU 131 judges whether or not the processes in the steps S202 to S206 were performed to all the broadcast channels represented by the above-described channel information.

As a result of the judgment in the step S207, if the processes were not performed to all the broadcast channels, the flow returns to the step S202 and thus the CPU 131 performs the following processes. On the other hand, if performed, the flow advances to a next step S208.

As above, the headers of the data sequentially received are checked. Then, if the page number represented by the checked header is coincident with the total number of the pages of the program, the same process is performed to the remaining channels, whereby the contents data of all the programs in the character broadcast can be obtained. Thus, the data of the contents (also to be referred as title hereinafter) for all the channels are stored in the text memory 123.

Subsequently, the CPU 131 performs a process on the contents data stored in the text memory 123 to extract therefrom the program number by using the keyword corresponding to the above information field previously stored in the program information storage unit 102 (step S208).

Concretely, for example, if the information field is assumed to concern the news of the political, financial and industrial information or the like, the contents data including the keyword “news” are initially searched by using the character code table 133.

At this time, since the title of the news program does not always include the term “news”, the corresponding program number is searched based on inference from plural conditions by combining a zone of the program number and other keywords.

Further, if it can not be judged only by the title whether or not the searched program is the corresponding program, the corresponding program is determined based on inference from a program number range of the contents program or searching of the keyword “news” in all the program contents (or program substance).

After the corresponding contents data was searched in the manner as above, the CPU 131 obtains the program number corresponding to the title and stores the obtained number in the program information storage unit 102 (step S209).

The above setting process may be performed simultaneously with the time when the power source of the apparatus is turned on or the time when the information is periodically outputted.

Subsequently, a process to periodically output the program indicated by the channel and the program number automatically set as above will be explained with reference to FIG. 7.

Initially, when the trigger button 101 is depressed by the user or the designated time (i.e., reservation time) stored in the program information storage unit 102 comes, the trigger signal is generated.

Thus, the CPU 131 starts executing the series of the processing programs by reading thereto the main program stored in the processing program storage unit 103 and the program of this process (FIG. 7) (step S301).

Then, the CPU 131 turns on a main power source of the apparatus mainbody except for the CPU 131 and a power source of the printer 151 (step S302).

Subsequently, the CPU 131 reads out the channel and the program number stored in the program information storage unit 102 as above (step S303).

Subsequently, the CPU 131 designates a reception broadcast channel to the tuner 111 by using the channel obtained in the step S303. Thus, the data (line data) of one horizontal scanning term is extracted by the character data extraction unit 121, and then the extracted data is once held in the buffer memory 122 (step S304).

After then, the CPU 131 analyzes the data held in the buffer memory 122.

That is, if there is the header start code (SOH) shown in FIG. 5 at the lead of this data, this data held in the memory 122 is judged to be the program managing data header or the page data header. Further, if the data header discriminating code at the ninth byte of this data is “02/0” (second bit in eight-bit data at ninth byte must be “0”), this data is judged to be the program managing data header. On the other hand, if the code at the ninth byte is “02/1” (second bit must be “1”), this data is judged to be the page data header. Further, the program numbers at eleventh and twelfth bytes of the header start code (SOH) are obtained. Then, if the program number is coincident with the program number read out in the step S303, this data is judged to be the program managing data header or the page data header, or to be the page data (step S305). According to the judged result, the flow advances to a step S307 if the data is the program managing data header or the page data header, while the flow advances to a step S306 if the data is the page data (step S305).

In the step S306, the CPU 131 once stores this data in the internal memory, and also once stores in the internal memory the page information d5 shown in FIG. 5 (i.e., page number) included in the header of this data.

In the step S307, the CPU 131 sets to the internal memory the information such as the total number of the pages, the data length and the like included in this data.

Further, the page data (text or body) received subsequently to the page data header is stored in the text memory 123. The page data (text of body) begins from the data line including the data block STX (“00/2”) (leading one byte), and terminates with the data line including the ending data block ETX (“00/3”), ETB (“01/7”) or EOT (“00/4”). Therefore, the data received between these data lines is the page data (text or body).

After the process in the step S306 or S307 terminated, the CPU 131 judges whether or not the total number of the pages set in the step S307 is coincident with the page number stored in the step S306 (step S308).

As a result of the judgment in the step S308, if not coincident, the flow returns to the step S305 and thus the CPU 131 performs the following processes. On the other hand, if coincident, the flow advances to a next step S309.

In the step S309, the CPU 131 stores in the text memory 123 the data stored in the internal memory in the step S306, i.e., all the data corresponding to the designated program numbers, as the text data.

Subsequently, the CPU 131 judges whether or not the processes in the steps S304 to S309 were performed to all the designated program numbers stored in the program information storage unit 102 (step S310).

Then, as a result of the judgment in the step S310, if the processes for all the designated program numbers do not yet terminate, the flow returns to the step S304, and the CPU 131 performs the following processes. On the other hand, if terminated, the flow advances to a next step S311.

As above, the headers of the data sequentially received are checked. Then, if the page number represented by the checked header is coincident with the total number of the pages of the program, the same process is performed to the remaining designated program numbers, whereby the data of the designated program numbers stored in the program information storage unit 102 can be obtained. Namely, for example, if the news program concerning the political, financial and industrial information or the like has been designated, the data concerning such a news number can be obtained.

In the step S311, the CPU 131 executes the layout process to print the data stored in the text memory 123 onto the output paper, and stores the data subjected to the layout process in the output layout memory 141.

In the character broadcast system in our country, the number of the characters capable of being displayed on one screen are two-byte characters (i.e., 15 characters×eight lines), whereby one screen can contain 120 characters maximumly. Therefore, for example, if the texts of the three programs each having six-page body are outputted, the text data of these texts goes in the A4-size and double-column (sideways) layout with character size of nine point or so.

Subsequently, the CPU 131 outputs the data stored in the output layout memory 141 to the printer control unit 142, whereby such the data is print outputted by the printer 151 (step S312).

After performing a program sorting process (step S313), the CPU 131 performs a process to turn off the power sources of the apparatus mainbody and the printer 151 (step S314), and the process terminates.

As described above, in the present embodiment, the channel and the program number corresponding to the information in the setting information field are automatically obtained by using the keyword, and the information concerning the program number of this channel is outputted at the setting time, whereby there is no need for the user to perform such the operation as in the conventional apparatus to designate the program number. That is, only by designating the desired information field, the user can easily and certainly obtain or watch the personal news at the determined time in any place within a range that the radio wave of the television broadcast reaches. Further, even if the user does not designate the desired information field, he can obtain the news in the field previously set at a time of product shipment in a factory. Furthermore, by depressing the trigger button 101, the user can obtain the latest news at that time. Moreover, since the obtained news can be hard copied, a display device for displaying the character broadcast becomes unnecessary, and also an interface for the display becomes unnecessary, thereby decreasing cost in the apparatus. For these reasons, a situation that the user can more easily utilize the character broadcast, the data broadcast and the like can be realized.

In the present embodiment, the information fields periodically outputted every day include the political, financial, industrial and business news and the like. However, the present invention is not limited to such the information. That is, the information field may include stock, sports, entertainment, weather forecast and traffic information news, and horse racing, art, hobby and local information, and the like. In this case, if buttons corresponding to such the information are provided and the user depresses the appropriate button, the output field can be changed. Further, a function to periodically change the output time may be added to the apparatus.

Furthermore, the present invention can be of course applied to an apparatus which receives and outputs text information superimposed on a voice sub-carrier in the television broadcast, the character broadcast superimposed on FM broadcast or satellite broadcast, or information superimposed on the data broadcast. Such a case will be described later.

In the above-described present embodiment, the processing program storage unit 103 and the program information storage unit 102 are provided within the reception apparatus 100. However, for example, it may be adopted the structure that the information to be essentially stored in each storage unit is stored in an external storage device such as a ROM card or the like, and the obtained external storage device is inserted into the apparatus mainbody.

Further, in the above present embodiment, the real-time television broadcast, and the character broadcast and the data broadcast relative to the television broadcast have been explained. However, for example, it may be adopted the structure that the data in the vertical blanking term including the character data as well as the broadcasting image is recorded in a magnetic recording apparatus or the like capable of recording a waveform in the vertical blanking term. By such the structure, as the recorded data is reproduced, the data can be also printed onto the printing paper irrespective of the actual broadcasting time. In this case, a terminal for introducing an output from the recording apparatus is provided instead of the tuner 111 in the structure shown in FIG. 1.

Furthermore, in the structure shown in FIG. 1, if the antenna 112, the tuner 111 and the printer 151 to output the data onto the printing paper are integrated with others, an apparatus capable of print outputting the latest information within the range that the broadcasting radio wave reaches can be realized.

Furthermore, in the above present embodiment, the output layout memory 141 for storing the output layout is provided. However, for example, if the data of several lines is sent to a buffer in the printer 151, the output layout memory 141 can be omitted. By doing so, the apparatus structure can be simplified, thereby further decreasing cost.

Subsequently, an another embodiment of the present invention will be explained. In the present embodiment, a system which receives data broadcast represented by, e.g., HTML (HyperText Markup Language) format and then prints obtained data by using a printer is disclosed.

The physical conditions of the character broadcast and the data broadcast shown in FIGS. 3 and 5 are identical with each other. That is, only the definition of prefixing (or prefix) unit (14 bits) and the contents of data block (176 bits) are different from each other.

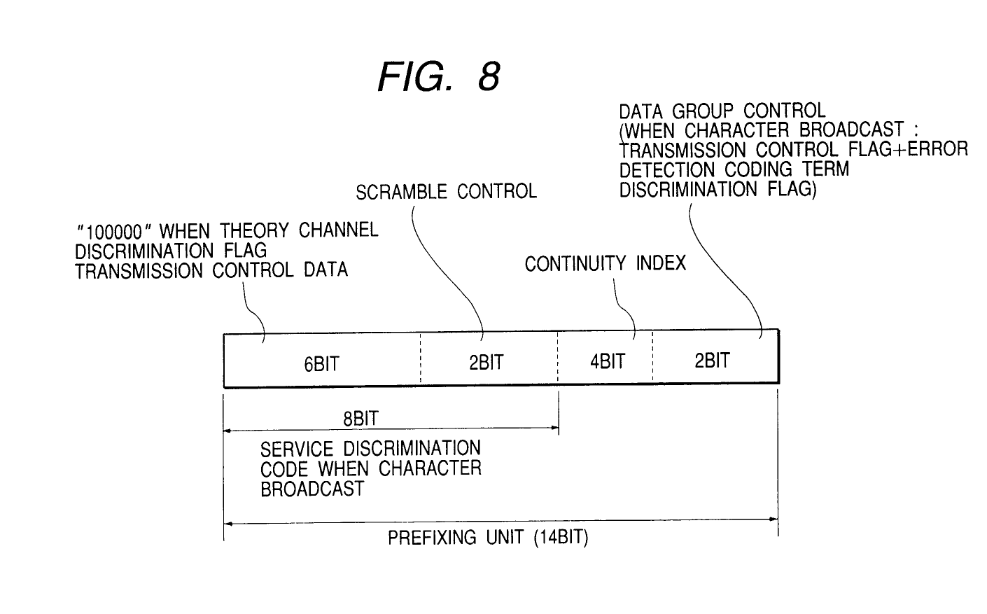

FIG. 8 shows the contents of information of the prefixing unit of 14 bits in the present embodiment. In the data broadcast, the prefixing unit consists of a theory (or logical) channel discrimination flag (6 bits), designation (2 bits) as to whether or not scramble control is to be performed, a binary value (4 bits) representing data continuity and a flag (2 bits) representing the lead or the tail of a data group, in due order. On the other hand, in the character broadcast, the prefixing unit consists of a service discrimination code (8 bits), a continuity index (4 bits), a transmission control flag (1 bit) and an error detection coding term discrimination flag (1 bit), in due order.

Bit arrangement usable in the theory channel discrimination flag (6 bits) in the data broadcast and bit arrangement usable in the character broadcast have been considered that they are not confused with each other. That is, in the data broadcast, 32 patterns of 64 patterns capable of being discriminated by the six bits are used for the bit arrangement. In the 32 patterns, the 30 patterns are allocated to 30 theory channels, and the remaining two patterns are respectively allocated to a time signal and transmission control data (TCD). Six patterns other than these 32 patterns are used in the character broadcast to designate a transmission mode, an auxiliary signal and a practical-use signal. Therefore, by checking the leading six bits in the prefixing unit in addition to the position on the vertical blanking term (VBI), it can be discriminated whether the objective data block is that in the data broadcast or that in the character broadcast.

Unlike the character broadcast, the data of various formats can be transmitted in the data broadcast. When a data pattern of the leading six bits in the prefixing unit is represented by “100000”, the definition of such a signal (i.e., transmitted data) represents the pattern of the transmission control data in the data broadcast. When such the pattern is designated, then a broadcast channel, a program number, a coding system, a theory channel number and the like of the data broadcast are designated in the subsequent data block. Further, the transmission control data (TCD) of the program is designated by the data of 17 bytes subsequent to a header (5 bytes).

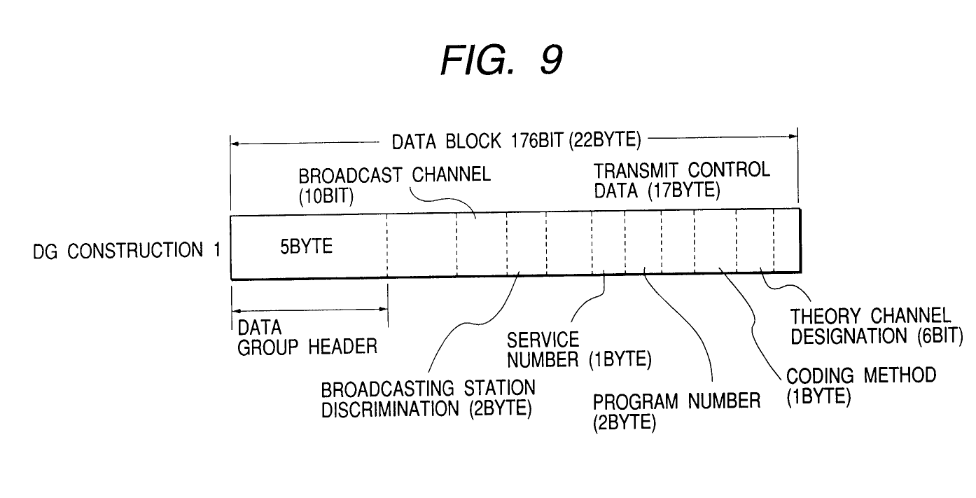

FIG. 9 shows the structure of the transmission control data.

In the data broadcast, there are two data block constructions, i.e., “DG construction 1” and “DG construction 2”. The transmission control data is transmitted by the DG structure 1. In this case, the data block includes data consisting of, in due order, a data group header (5 bytes), a broadcast channel (10 bits), broadcasting station discrimination (2 bytes), a program service number (1 byte), a program number (2 bytes), a coding method or system (1 byte), theory channel designation (6 bits) and the like.

The data group header in the DG construction 1 includes data group discrimination (4 bits), information (4 bits) representing continuous transmission of the group, information (1 bit) representing a connecting state between the data groups connected to each other and respectively having different contents, information (7 bits) representing order of the data groups, and information (24 bits) representing sizes of the data groups. One transmission control data is used to control transmission of all the programs to be transmitted in the data channel until next transmission control data becomes effective.

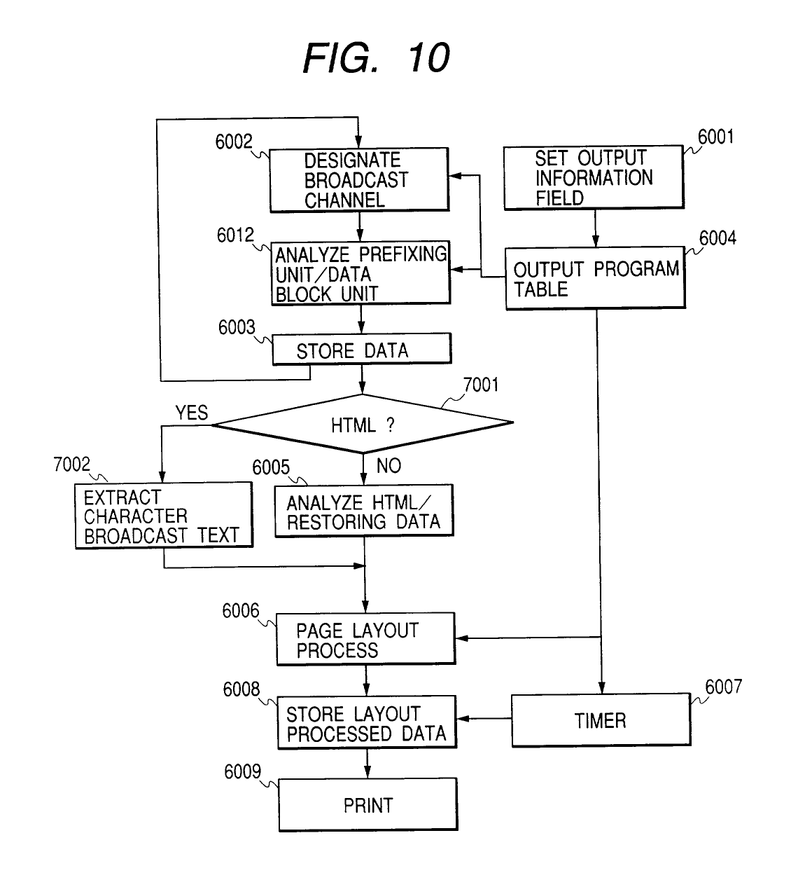

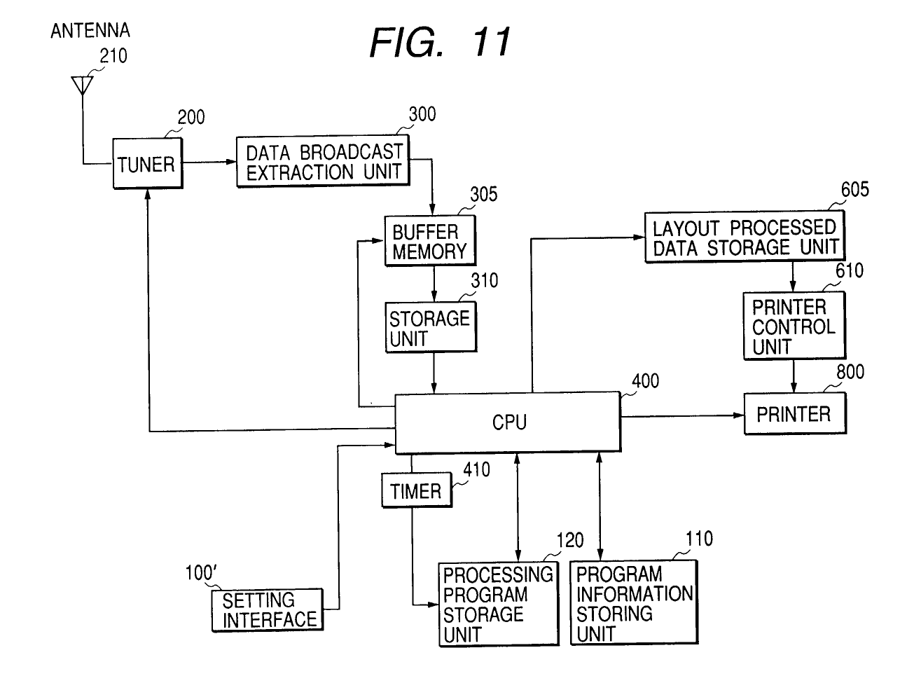

Although the figure numbers are reversed, FIG. 11 is a block diagram showing the another embodiment of the present invention, and FIG. 10 is a flow chart showing control procedure in the another embodiment.

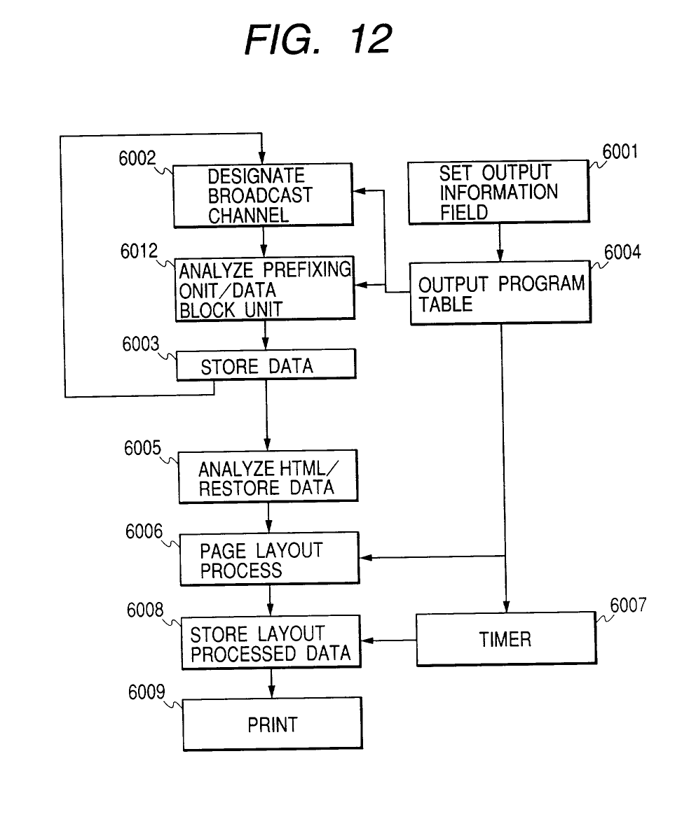

In FIG. 11, reference numeral 110 denotes a program information storage unit. In the unit 110, an information field of the program to be periodically or arbitrarily outputted, a broadcasting station (broadcast channel) corresponding to the field, and a combination of a service number or the program number and an output time have been stored in the form of a table. Also, an output layout condition corresponding to program contents in the information field has been stored in the unit 110. For example, in the unit 110, layout information as to whether the layout is one-column layout, two-column layout or more complicated layout has been previously prepared in correspondence with the program. Reference numeral 120 denotes a processing program storage unit in which a series of processing programs (described later) have been stored. FIG. 12 is a flow chart showing flow of such the processing programs. Reference numeral 100′ denotes a setting user interface. Although the interface 100′ is not always used, it is used in the arbitrary outputting of the program information as a trigger key, in the setting of the output program, or the like.

Reference numeral 210 denotes an antenna which receives a radio wave. Reference numeral 200 denotes a tuner which is tuned to a broadcast wave to select the broadcast channel. That is, the tuner 200 fetches a television image signal from the radio wave. Reference numeral 300 denotes a data broadcast extraction unit which extracts the prefixing unit (prefix unit) and the data block from the data line superimposed on a data broadcast multiplexing position in the vertical blanking term shown in FIG. 1. Reference numeral 305 denotes a buffer which temporarily stores the extracted data. The theory channel number, the data continuity, and the lead or the tail of the data block can be known from the information in the prefixing unit. Further, when transmission control of the program is defined, the service number and the program number can be known from the subsequent data block. Then, the obtained information is checked with the contents of the program information storage unit 110. Thus, unnecessary data is cancelled or deleted, while necessary program data is selected. Reference numeral 310 denotes a storage unit which stores the data coincident with the program number in the program information storage unit 110, in correspondence with the program number.

Reference numeral 605 denotes a layout processed data storage unit which performs HTML analyzing on the data stored in the storage unit 310 to release a tag, restores the original data, collects the restored data in a unit of sorting information in accordance with a layout instruction stored in the program information storage unit 110, and stores a result of a page layout process on the data capable of being outputted to a printer. Further, reference numeral 610 denotes a printer control unit, 800 denotes the printer, 400 denotes a CPU such as a microcomputer or the like, and 410 denotes a timer.

The processing program for the apparatus has been stored in the processing program storage unit 120. Hereinafter, the processing program and the operation of the entire apparatus will be explained with reference to the block diagram shown in FIG. 11. Further, the flow of the processing program is shown in FIG. 12.

Initially, the information field to be printed out and the data included in this field are set (step 6001).

The output fields are sorted to, e.g., the political and financial news, the stocks, the sports and entertainment news, the weather forecast, the traffic information, cooking, the local information, the public information from autonomy, the horse racing, the arts, the hobby and the like, and are added with the numbers corresponding thereto. Then, an output program table in which the service number or the program number of one or plural data broadcast corresponding to the sorted contents, the broadcast channel including such the program, the print output time corresponding to the sorting, and a paper size and a layout condition at the time when the sorted information is outputted to the printer are corresponded to others is formed and stored in the program information storage unit 110 (step 6004).

In order to set the data, following several methods are considered.

(1) The data is initially set as a default condition at the time when the processing program is manufactured.

(2) The output information field is set on the keyword, and the service program coincident with the keyword is automatically selected and set.

(3) The data is set by using a user interface.

In this case, a method in which the program sorting numbers directly obtained from the user interface by using numeral keys are displayed as program sorting titles on an interface liquid crystal screen and then the appropriate title is selected from among the displayed titles is also effective. By the above process, the table of the output programs is formed and stored in the program information storage unit 110.

In the data fetching process, all the data broadcast programs automatically designated on the output program table as far as the apparatus is in an operating state are rounded to be checked and thus-obtained data is stored. That is, the broadcast channel set in the output program table (step 6004) is designated (step 6002). Thus, the data which was extracted through the antenna 210, the tuner 200 and the data broadcast extraction unit 300 and has been temporarily stored in the buffer 305 is analyzed (step 6012). The contents of the prefixing unit in the data block and the data block are sorted or divided into directories corresponding to the theory channel numbers of the prefixing unit. Then, as the continuity index is confirmed, the obtained data is stored in the storage unit 310 in the unit of the data (data block) within the range from the data group leading flag “1” to the trailing (or ending) flag “1”. Such the process is repeated to all the programs designated on the output program table. Thus, the program coincident with the sorting number in the program information storage unit 110 is extracted, and the continuous pages of the program is stored, in due order, for each extracted program (step 6003).

The above processes are performed to all the programs designated on the output program table.

By the above processes, the latest data of all the programs designated on the output program table is stored in the storage unit 310.

In a step 6005, the program data corresponding to the sorting information is sequentially fetched from the data stored in the storage unit 310 in accordance with the table stored in the program information storage unit 110, and the fetched data is analyzed in correspondence with its coding method (or system). If such the data is HTML text data, the data is analyzed according to its syntax to restore the original data. In the HTML, the text information and the image information are added with information of their styles, colors or arrangement as the tags. Generally, since a specification of the HTML has been clearly determined, anyone can refer thereto.

By adding a character string called the tag into the text, an HTML file can be formed. Since the HTML file has a text editor function, if the file can be stored as the text file, any specific application software or the like is unnecessary.

In the contents of the HTML file, the title which is sandwiched between codes <TITLE> and </TITLE> corresponds to the output information field, and the subsequent part which is sandwiched between codes <BODY> and </BODY> is a page body. The body includes a headline and a text body, or includes an illustration or a still image displayed by a code IMAGE SRC=“ . . . ”, or an image fit in a table sandwiched between codes <table> and </table>.

The tag is released from the HTML file added with the tag as above with reference to an HTML dictionary, and the original data is restored. By collecting the several restored data, the output information corresponding to one sorting number can be obtained.

On the original data restored as above, the layout process is performed in the unit of page according to the paper size and the layout information designated on the output program table (step 6006). If the printer previously contains a font or a pattern, it is necessary to perform the layout process in consideration of its size. On the other hand, if the data is outputted to the printer which does not contain the font or the like, a result of the layout process is stored as the image expressed in the unit of pixel. Then, the data subjected to the layout process in the unit of page as above is stored in the layout processed data storage unit 605 in the order of page and in the unit of program (step 6008). Subsequently, the trigger is generated at the time designated on the output program table in the program information storage unit 110 (step 6007), whereby the data which was sorted and stored as above is outputted onto a paper by the printer 800 through the printer control unit 610 (step 6009).

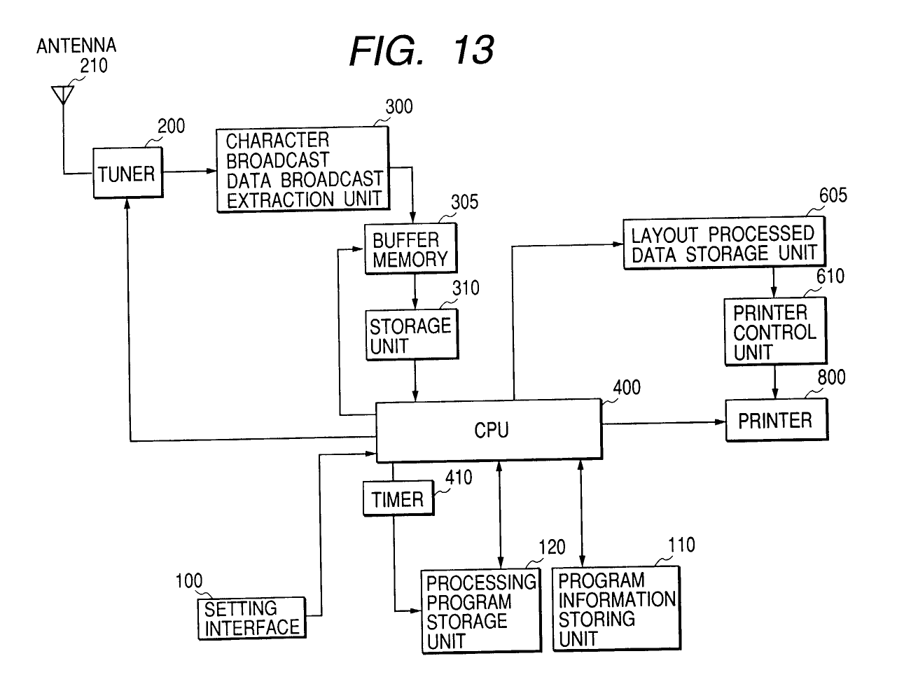

FIG. 13 is a block diagram showing a still another embodiment of the present invention.

The block diagram in FIG. 13 is different from the block diagram in FIG. 11 concerning the data broadcast only in a function of the data extraction unit. That is, the data broadcast extraction unit 300 in FIG. 11 extracts the data at the data broadcast multiplexing position in the vertical blanking term shown in FIG. 2, while a block 300 (i.e., character broadcast and data broadcast extraction unit) in FIG. 13 extracts not only the data at the data broadcast superimposing position but also the data at the character broadcast superimposing position.

The processing program for the apparatus in the present embodiment has been stored in a processing program storage unit 120. Although the figure numbers are reversed, FIG. 10 is the flow chart showing the flow of this processing program. The operation of the entire apparatus will be explained with reference to the block diagram shown in FIG. 13.

Initially, the information field to be printed out and the data included in this field are set (step 6001). The output fields are sorted to, e.g., the political and financial news, the stocks, the sports and entertainment news, the weather forecast, the traffic information, the cooking, the local information, the public information from autonomy, the horse racing, the arts, the hobby and the like, and are added with the numbers corresponding thereto. Then, the output program table in which the one or plural program title corresponding to the sorted contents, distinguishment of the character broadcast or the data broadcast, the broadcast channel including such the program, the print output time corresponding to the sorting, and the paper size and the layout condition corresponding to the sorting are corresponded to others is formed and stored in a program information storage unit 110 (step 6004).

In order to set the data, the following several methods are considered.

(1) The data is initially set as the default condition.

(2) The output information field is set on the keyword, and the service program number coincident with the keyword is automatically selected and set.

(3) The data is set by using the user interface.

In this case, the method in which the program sorting numbers directly obtained from the user interface by using numeral keys are displayed as the program sorting titles on an interface liquid crystal screen and then the appropriate title is selected from among the displayed titles can be considered. By the above process, the table of the output programs is formed and stored in the program information storage unit.

In the data fetching process, as to all the character broadcast programs and the data broadcast programs automatically designated on the output program table as far as the apparatus is in the operating state, the designated channel and the program number are checked with each other, and as these programs are rounded, the obtained data is stored.

That is, the broadcast channel set in the output program table (step 6004) is designated (step 6002). Thus, the data is extracted through an antenna 210, a tuner 200 and the character broadcast and data broadcast extraction unit 300, and the prefixing unit (or prefix unit) of the data block and the contents of the data block are temporarily stored in a buffer 305. A prefixing unit data block analyzing process is performed to the stored data (step 6012). As described above, if the leading six-bit data in the prefixing unit are checked, the character broadcast or the data broadcast can be discriminated, because the transmission mode, the auxiliary signal and the practical-use signal in the character broadcast or the theory channel, the time signal and the transmission control signal in the data broadcast have been defined in the prefixing unit without any overlapping.

Therefore, the leading six bits in the prefixing unit of the data are initially checked to discriminate the character broadcast or the data broadcast.

If the judged result indicates the data broadcast, the data of the program corresponding to the sorting information is stored in a storage unit 310 in the same manner as explained in the above first embodiment (6003).

On the other hand, if the judged result indicates the character broadcast, the data in the data block is checked. Then, if there is the header start code (SOH) at the lead of the data block, such the header is judged to be the header of the program managing data or the page data. As apparent from the data construction (or structure) of FIG. 5 explained in the previous embodiment, the header has the header start code (SOH) at its leading first byte and the data header discrimination code at its ninth byte. If the data header discrimination code is represented by “02/0 (upper four bits/lower four bits)”, the objective data is the program managing data. On the other hand, if the code is represented by “02/1”, the objective data is the page data header. Further, there are the program number data (12 bits) at the 11th and 12th bytes. If the program number data is coincident with the program number designated on the program output table, the obtained page data is stored in the storage unit 310 (step 6003).

The above processes are performed to all the programs designated on the output program table.

Thus, the latest data of all the programs designated on the output program table is stored in the storage unit 310.

Then, the program data corresponding to the sorting information is sequentially fetched from the data stored in the storage unit 310 in accordance with the table stored in the program information storage unit 110, and it is judged whether or not the fetched data is the HTML data (step 7001). Such the judgment can be performed by checking whether the stored data includes a <HTML> tag.

As described in the first embodiment, if the fetched data is the HTML data, the data is analyzed according to its syntax and thus the original data is restored (step 6005).

In the character broadcast, a character broadcast text extraction process is performed (step 7002). The text information is transmitted as the code in the character broadcast. Therefore, if the printer contains the font, the text information is checked with a font table in the printer to restore the text. On the other hand, if the printer does not contain any font, the text information is checked with a font table for a display unit used in the character broadcast to restore the text. Further, if pattern data is obtained, screen data is restored by using the data in a pattern table for the display unit in the character broadcast.

The layout process on the original data restored as above is performed, in the unit of page, on the paper of which size was designated on the output program table (step 6006). If the printer previously contains the font or the pattern, it is necessary to perform the layout process in consideration of its size. On the other hand, if the data is outputted to the printer which does not contain the font or the like, the result of the layout process is stored as the image expressed in the unit of pixel. Then, for all the programs, the data subjected to the layout process in the unit of page as above is stored in a layout processed data storage unit 605 in the order of page and for each sorting (step 6008). Subsequently, the trigger is generated at the time designated on the output program table provided in the program information storage unit 110 (step 6007), whereby the data which was sorted and stored as above is outputted by a printer 800 through a printer control unit 610 (step 6009).

In the embodiments shown in FIGS. 11 and 13, the system in which the processing program storage unit and the program information storage unit have been previously provided in the apparatus mainbody was used. However, it is apparent that a system in which the processing program or the program information is previously stored in an external storage unit such as the ROM card or the like and then the external storage unit is inserted into the apparatus mainbody can be easily realized.

Further, in the above description, the example in which the data of HTML format is managed in the data broadcast was explained. However, since an A4-size facsimile signal is also defined in the data broadcast, it is apparently possible to restore and expand the facsimile signal into bit map information, and output the obtained information to the printer. Further, since still image data based on lateral 720 dots x longitudinal 480 lines, lateral 1920 dots x longitudinal 1035 lines or the like is also defined in the data broadcast, it is apparently possible to output such the data to the printer.

Furthermore, in the above description, although the method in which all the programs designated on the output program table are rounded and thus the latest data is always stored was explained, the large-capacity storage unit is necessary in such the method. Therefore, in order to avoid such a situation, the operation may start at an output time of the specific field information or at a time went back from such the output time by a predetermined period of time. By doing so, the same object can be achieved even by the small-capacity storage unit.

Furthermore, in the above description, although the page data on all the sorting information to be outputted was stored in the layout processed data storage unit, the large-capacity storage unit is necessary also in this case. Therefore, in order to avoid such the situation, if it starts the page layout process after generating the trigger signal, the capacity of the layout processed data storage unit can be made small.

Furthermore, in the above description, the data which is superimposed on the vertical blanking term of the analog ground wave was described. However, the similar concept can be applied to the data which is superimposed on an MPEG (Motion Picture Expert Group) bit stream transmitted by using the ground wave or by the satellite. Moreover, it is obviously understood that the similar concept can be applied to the data broadcast superimposed on the voice sub-carrier in the television broadcast, the character broadcast in the FM broadcast or the information output in the data broadcast. In addition, such the concept can be applied to a case where push-type media delivered through a network such as the internet are received and then printed out.

According to the above-explained embodiments, the text information including the image can be obtained on the paper at the determined time every day and everywhere as far as the television broadcast reaches, without interrupting the image on the television screen. Further, the desired information can be outputted on the paper at the arbitrary time.

Furthermore, according to the present invention, the display unit to display the character broadcast or the data broadcast may not be used, thereby realizing the entire apparatus at low cost.

The present invention may be applied to a system consisting of plural equipments or may be applied to such the apparatus comprising one equipment as shown in FIG. 1.

Further, it is obviously understood that the object of the present invention can be achieved by supplying a storage medium storing program codes of a software to realize functions of a host computer and terminals in the above-described embodiments to the system or the apparatus, and then reading and executing the program codes stored in the storage medium with a computer (CPU or MPU) of the system or the apparatus.

In this case, the program codes themselves read out of the storage medium realize the functions of the above-described embodiments, whereby the storage medium storing such the program codes construct the present invention.

As such the storage medium to supply the program codes, for example, a floppy disk, a hard disk, an optical disk, a magneto-optical disk, a CD-ROM, a CD-R, a magnetic tape, a non-volatile memory card, an ROM or the like can be used.

Further, it is obviously understood that the present invention incorporates not only a case where the functions of the above-described embodiments are realized by executing the program codes read by the computer, but also a case where an OS (operating system) or the like operating in the computer performs the part or all of the actual process based on instructions of the program codes and the functions of the above-described embodiments are realized by such the process.

Furthermore, it is also obviously understood that the present invention incorporates a case where, after the program codes read from the storage medium have been written into a memory provided for a function expansion board inserted into the computer or a function expansion unit connected to the computer, the CPU or the like provided for the function expansion board or the function expansion unit performs the part or all of the actual process based on the instructions of the program codes, and the functions of the above-described embodiments are realized by such the processes.

Furthermore, the present invention can be applied not only to the apparatus which receives and processes the character broadcast, the data broadcast or the like including the data superimposed on the radio wave, but also to an apparatus which receives and processes data of a predetermined system including additional data. For example, the present invention can be applied to the apparatus which receives the data transmitted through the internet and then processes the date added to the received data.

According to the above-described embodiments of the present invention, following effects can be derived.

1. It can be derived the effect that, since it is judged using the keyword concerning the specific field information whether or not the superimposed data received is the data of the program corresponding to the specific field information, the data of the program corresponding to the specific field information can be searched and extracted from among the superimposed data received, and the information of the program number and the channel can be obtained from the extracted program data. That is, even if the program number and the channel are not designated, only by designating the specific field information, the program number and the channel corresponding to such the information can be obtained. Thus, the program number and the channel can be automatically set and then received, and the data of the program corresponding to the specific field information can be outputted. Therefore, such the user's operation as conventionally performed to designate the program number and the channel becomes unnecessary, whereby the desired information can be easily obtained only by designating the desired information field. Further, even if the desired information field is not designated, the program information which has been set at the time of shipment in the factory can be obtained.

2. In the item 1, it can be further derived the effect that, even in the television broadcast, the FM broadcast, the satellite broadcast or the like, the data of the program corresponding to the specific field information can be easily obtained from among the data superimposed on such the broadcast.

3. In the item 1, it can be further derived the effect that the data of the programs in the character broadcast and the data broadcast both corresponding to the specific field information can be easily obtained.

4. In the item 1, it can be further derived the effect that, if the keyword concerning the specific field information exists in the data of the page of the table of contents or the data of the program contents included in the superimposed data received, such the superimposed data can be judged to be the data of the program corresponding to the specific field information. Thus, the data of the program corresponding to the specific field information can be more certainly obtained.

5. In the item 1, it can be further derived the effect that, everywhere as far as the broadcast wave reaches, the data of the program corresponding to the specific field information can be obtained at the desired time only by operating the instruction means. Thus, the latest information can be easily obtained.

6. In the item 1, it can be further derived the effect that the desired information field can be designated from among the various information fields concerning, e.g., the news of the political, financial and industrial information and the like, and the data of the program corresponding to the designated information can be personally obtained.

7. In the item 1, it can be further derived the effect that, everywhere as far as the broadcast wave reaches, the data of the program corresponding to the specific field information can be obtained at the determined time every day.

8. In the item 6 or 7, it can be further derived the effect that the output time or the output field of the information can be changed and corrected.

9. In the item 1, it can be further derived the effect that the data of the program corresponding to the specific field information can be layout processed and then outputted.

10. In the item 9, it can be further derived the effect that the data of the program corresponding to the specific field information subjected to the layout process can be obtained in the form printed on the printing paper, i.e., as the hard copy. Thus, the obtained information can be accurately grasped in the form easy to be watched. Further, since the display apparatus or the like to display the information becomes unnecessary and also the interface or the like for the displaying becomes unnecessary, the construction of the apparatus can be simplified, thereby decreasing the cost for the apparatus.

11. In the item 9, it can be further derived the effect that the data of the program corresponding to the specific field information subjected to the layout process can be displayed on the screen in the form easy to be watched. Thus, the displayed information can be accurately grasped.

12. In the item 1, it can be further derived the effect that the data of the program corresponding to the specific field information can be recorded and stored in the recording medium, and also the information reproduced from the medium can be obtained.

13. In the item 1, it can be further derived the effect that, together with the broadcasting image and the like, the data of the program corresponding to the specific field information superimposed on such the image can be recorded and stored in the recording medium, and then the stored data can be reproduced. Thus, the data of the program corresponding to the specific field information can be easily obtained irrespective of the actual broadcasting time.

14. In the item 1, it can be further derived the effect that the data of the program corresponding to the specific filed information can be obtained as the hard copy everywhere as far as the radio wave reaches.

15. It can be derived the effect that, even if the operation to designate the program number and the channel is not performed, the program number and the channel of the program corresponding to the specific field information are automatically set, the series of the processes are executed based on the setting channel and the setting program number, and the information obtained as the result of the processes, i.e., the data of the program corresponding to the specific field information, is print outputted. Thus, such the operation as conventionally performed to designate the program number and the channel becomes unnecessary, and, everywhere as far as the broadcast wave reaches, the information can be personally obtained at the determined time or the like every day. Further, as far as the broadcast wave reaches, the latest information can be obtained as the hard copy only by depressing the button. Furthermore, since the display apparatus or the like to display the data of the program corresponding to the specific field information becomes unnecessary and also the interface or the like for the displaying becomes unnecessary, the construction of the apparatus can be simplified, thereby decreasing the cost for the apparatus.

16. It can be derived the effect that the information processing apparatus which provides the effects of the items 1 to 15 can be applied to the system consisting of the plural equipments.

17. It can be derived the effect that, since it is judged using the keyword concerning the specific field information whether or not the superimposed data received is the data of the program corresponding to the specific field information, the data of the program corresponding to the specific field information can be searched and extracted from among the superimposed data received, and the information of the program number and the channel can be obtained from the extracted program data. That is, even if the program number and the channel are not designated, only by designating the specific field information, the program number and the channel corresponding to such the information can be obtained. Thus, the program number and the channel can be automatically set and then received, and the data of the program corresponding to the specific field information can be outputted. Therefore, such the user's operation as conventionally performed to designate the program number and the channel becomes unnecessary, whereby the desired information can be easily obtained only by designating the desired information field. Further, even if the desired information field is not designated, the program information which has been set at the time of shipment in the factory can be obtained.

18. In the item 17, it can be further derived the effect that, even in the television broadcast, the FM broadcast, the satellite broadcast or the like, the data of the program corresponding to the specific field information can be easily obtained from among the data superimposed on such the broadcast.

19. In the item 17, it can be further derived the effect that the data of the programs in the character broadcast and the data broadcast both corresponding to the specific field information can be easily obtained.

20. In the item 17, it can be further derived the effect that, if the keyword concerning the specific field information exists in the data of the page of the table of contents or the data of the program contents included in the superimposed data received, such the superimposed data can be judged to be the data of the program corresponding to the specific field information. Thus, the data of the program corresponding to the specific field information can be more certainly obtained.

21. In the item 17, it can be further derived the effect that, everywhere as far as the broadcast wave reaches, the data of the program corresponding to the specific field information can be obtained at the desired time only by operating the button or the like for instructing the outputting. Thus, the latest information can be easily obtained.

22. In the item 17, it can be further derived the effect that the desired information field can be designated from among the various information fields concerning, e.g., the news of the political, financial and industrial information and the like, and the data of the program corresponding to the designated information can be personally obtained.

23. In the item 17, it can be further derived the effect that, everywhere as far as the broadcast wave reaches, the data of the program corresponding to the specific field information can be obtained at the determined time every day.

24. In the item 22 or 23, it can be further derived the effect that the output time or the output field of the information can be changed and corrected.

25. In the item 17, it can be further derived the effect that the data of the program corresponding to the specific field information can be layout processed and then outputted.

26. In the item 25, it can be further derived the effect that the data of the program corresponding to the specific field information subjected to the layout process can be obtained in the form printed on the printing paper, i.e., as the hard copy. Thus, the obtained information can be accurately grasped in the form easy to be watched. Further, since the display apparatus or the like to display the information becomes unnecessary and also the interface or the like for the displaying becomes unnecessary, the construction of the apparatus operating in the processing steps stored in the storage medium can be simplified, thereby decreasing the cost for the apparatus.

27. In the item 25, it can be further derived the effect that the data of the program corresponding to the specific field information subjected to the layout process can be displayed on the screen in the form easy to be watched. Thus, the displayed information can be accurately grasped.

28. In the item 17, it can be further derived the effect that the data of the program corresponding to the specific field information can be recorded and stored in the recording medium, and also the information reproduced from the medium can be obtained.

29. In the item 17, it can be further derived the effect that, together with the broadcasting image and the like, the data of the program corresponding to the specific field information superimposed on such the image can be recorded and stored in the recording medium, and then the stored data can be reproduced. Thus, the data of the program corresponding to the specific field information can be easily obtained irrespective of the actual broadcasting time.

30. It can be derived the effect that the data of the program corresponding to the specific filed information can be obtained as the hard copy everywhere as far as the radio wave reaches.

31. It can be derived the effect that, even if the operation to designate the program number and the channel is not performed, the program number and the channel of the program corresponding to the specific field information are automatically set, the series of the processes are executed based on the setting channel and the setting program number, and the information obtained as the result of the processes, i.e., the data of the program corresponding to the specific field information, is print outputted. Thus, such the operation as conventionally performed to designate the program number and the channel becomes unnecessary, and, everywhere as far as the broadcast wave reaches, the information can be personally obtained at the determined time or the like every day. Further, as far as the broadcast wave reaches, only by depressing the button, the latest information at that time can be obtained as the hard copy. Furthermore, since the display apparatus or the like to display the data of the program corresponding to the specific field information becomes unnecessary and also the interface or the like for the displaying becomes unnecessary, the construction of the apparatus can be simplified, thereby decreasing the cost for the apparatus.

32. It can be derived the effect that the storage medium which provides the effects of the items 17 to 31 can be applied to the computer which performs the operation controlling of the system consisting of the plural equipments.

33. It can be derived the effect that, since it is judged using the keyword concerning the specific field information whether or not the received additional data is the data corresponding to the specific field information, the data corresponding to the specific field information can be obtained. Therefore, only by designating the desired information field, such the desired information can be easily obtained. Further, even if the desired information field is not designated, the program information which has been set at the time of shipment in the factory can be obtained.

34. In the item 33, it can be further derived the effect that, even in the television broadcast, the FM broadcast, the satellite broadcast or the like, the data of the program corresponding to the specific field information can be easily obtained from among the data superimposed on such the broadcast.

35. In the item 33, it can be further derived the effect that the data of the programs in the character broadcast and the data broadcast both corresponding to the specific field information can be easily obtained.

36. In the item 33, it can be further derived the effect that, if the keyword concerning the specific field information exists in the data of the page of the table of contents or the data of the program contents included in the received additional data, such the additional data can be judged to be the data corresponding to the specific field information. Thus, the data corresponding to the specific field information can be more certainly obtained.

37. In the item 33, it can be further derived the effect that, everywhere as far as the data reception is possible, the data corresponding to the specific field information can be obtained at the desired time only by operating the instruction means. Thus, the latest information can be easily obtained.

38. In the item 33, it can be further derived the effect that the desired information field can be designated from among the various information fields concerning, e.g., the news of the political, financial and industrial information and the like, and the data corresponding to the designated information can be personally obtained.

39. In the item 33, it can be further derived the effect that, everywhere as far as the data reception is possible, the data corresponding to the specific field information can be obtained at the determined time every day.

40. In the item 38 or 39, it can be further derived the effect that the output time or the output field of the information can be changed and corrected.

41. In the item 33, it can be further derived the effect that the data corresponding to the specific field information can be layout processed and then outputted.

42. In the item 41, it can be further derived the effect that the data corresponding to the specific field information subjected to the layout process can be obtained in the form printed on the printing paper, i.e., as the hard copy. Thus, the obtained information can be accurately grasped in the form easy to be watched. Further, since the display apparatus or the like to display the information becomes unnecessary and also the interface or the like for the displaying becomes unnecessary, the construction of the apparatus can be simplified, thereby decreasing the cost for the apparatus.

43. In the item 41, it can be further derived the effect that the data corresponding to the specific field information subjected to the layout process can be displayed on the screen in the form easy to be watched. Thus, the displayed information can be accurately grasped.

44. In the item 33, it can be further derived the effect that the data corresponding to the specific field information can be recorded and stored in the recording medium, and also the information reproduced from the medium can be obtained.

45. In the item 33, it can be further derived the effect that, together with the received image and the like, the data corresponding to the specific field information added thereto can be recorded and stored in the recording medium, and then the stored data can be reproduced. Thus, the data corresponding to the specific field information can be easily obtained irrespective of the actual receiving time.

46. In the item 33, it can be further derived the effect that, everywhere as far as the data reception is possible, the data corresponding to the specific filed information can be obtained as the hard copy.

Many widely different embodiments of the present invention may be constructed without departing from the spirit and scope of the present invention. It should be understood that the present invention is not limited to the specific embodiments described in the specification, except as defined in the appended claims.

What is claimed is:

1. An information processing apparatus comprising:
reception means for receiving broadcast of a predetermined system, including data;
extraction means for extracting the data received by said reception means;
judgment means for judging whether or not the data extracted by said extraction means is data of a program corresponding to specific field information, by using a keyword; and
output means for performing a predetermined process to the data extracted by said extraction means and outputting the processed data, based on a judged result of said judgment means.

2. An apparatus according to claim 1, wherein the broadcast of the predetermined system is at least any of television broadcast including data superimposed on a vertical blanking term, television broadcast including data superimposed on a voice sub-carrier, FM broadcast including data superimposed on a radio wave, satellite broadcast including data superimposed on a radio wave, and broadcast transmitted through an internet.

3. An apparatus according to claim 1, wherein the data is at least any of data in character broadcast and data in data broadcast.

4. An apparatus according to claim 1, wherein said judgment means judges whether or not the data extracted by said extraction means is the data of the program corresponding to the specific field information, by judging whether or not the keyword concerning the specific field information is included in any of data of a table of contents and data of program contents both included in the data extracted by said extraction means.

5. An apparatus according to claim 1, further comprising instruction means for instructing said output means to output the data.

6. An apparatus according to claim 1, further comprising setting means for setting information including the specific field information.

7. An apparatus according to claim 1, further comprising setting means for setting information including an output time of said output means.

8. An apparatus according to claim 6 or 7, wherein said setting means can add and change the setting information.

9. An apparatus according to claim 1, wherein said output means performs a layout process to lay out the data extracted by said extraction means on a predetermined output format.

10. An apparatus according to claim 9, wherein said output means print outputs the data subjected to the layout process.

11. An apparatus according to claim 9, wherein said output means display outputs the data subjected to the layout process.

12. An apparatus according to claim 1, wherein said output means outputs the data to an apparatus which performs recording and reproducing on a recording medium.

13. An apparatus according to claim 1, further comprising record and reproduction means for recording onto a recording medium a broadcasting wave received by said reception means together with data superimposed on the wave, and inputting a reproduction signal of the recorded wave to said extraction means.

14. An apparatus according to claim 1, wherein each of said means is provided in a printer.

15. An information processing apparatus comprising:
search and extraction means for extracting data of a program corresponding to specific field information from among data included in broadcast of a predetermined system;
layout means for analyzing the data extracted by said search and extraction means and performing a layout process on the analyzed data;
output means for outputting the data subjected to the layout process by said layout means, to a printing apparatus; and
control means for controlling an operation of the entire apparatus such that the operations of said respective means are sequentially performed using a preset time or button depressing as a trigger,
wherein said search and extraction means searches the data of the program corresponding to the specific field information based on a keyword, from data of a table of contents and data of program contents both included in the data in the broadcast of the predetermined system.

16. An information processing system which includes the information processing apparatus according to claim 15.

17. A storage medium which is readably stored in a processing apparatus, said medium storing:
a reception step of receiving broadcast of a predetermined system, including data;
an extraction step of extracting the data included in a broadcasting wave received in said reception step;
a judgment step of judging whether or not the data extracted in said extraction step is data of a program corresponding to specific field information, by using a keyword; and
an output step of performing a predetermined process to the data extracted in said extraction step and outputting the processed data, based on a judged result in said judgment step.

18. A medium according to claim 17, wherein the broadcast of the predetermined system is at least any of television broadcast including data superimposed on a vertical blanking term, television broadcast including data superimposed on a voice sub-carrier, FM broadcast including data superimposed on a radio wave, satellite broadcast including data superimposed on a radio wave, and broadcast transmitted through an internet.

19. A medium according to claim 17, wherein the superimposed data is at least any of data in character broadcast and data in data broadcast.

20. A medium according to claim 17, wherein said judgment step judges whether or not the data extracted in said extraction step is the data of the program corresponding to the specific field information, by judging whether or not the keyword concerning the specific field information is included in any of data of a table of contents and data of program contents both included in the data extracted in said extraction step.

21. A medium according to claim 17, further storing an instruction step of instructing said output step to output the data.

22. A medium according to claim 17, further storing a setting step of setting information including the specific field information.

23. A medium according to claim 17, further storing a setting means for setting information including an output time in said output step.

24. A medium according to claim 22 or 23, wherein said setting step includes a step of capable of adding and changing the setting information.

25. A medium according to claim 17, wherein said output step includes a step of laying out the data extracted in said extraction step on a predetermined output format.

26. A medium according to claim 25, wherein said output step includes a step of print outputting the laid-out data.

27. A medium according to claim 25, wherein said output step includes a step of display outputting the laid-out data.

28. A medium according to claim 17, wherein said output step includes a step of outputting the data to an apparatus which performs recording and reproducing on a recording medium.

29. A medium according to claim 17, further storing a step of recording onto a recording medium the broadcasting wave received in said reception step together with data superimposed on the wave, and inputting a reproduction signal of the recorded wave to an extraction means.

30. A medium according to claim 17, wherein said medium is provided within an apparatus integrally consisting of a reception device to receive the broadcasting wave and a printer, and each step in said medium is read by a processing device performing operation controlling to the apparatus.

31. A storage medium which is readably stored in a processing apparatus, said medium comprising:
a search and extraction step of extracting data of a program corresponding to specific field information from among data included in broadcast of a predetermined system;
a layout step of analyzing the data extracted in said search and extraction step and performing a layout process on the analyzed data:
an output step of outputting the data subjected the layout process in said layout step, to a printing apparatus; and
a control step of performing control such that the operations in said respective step are sequentially performed using a preset time or button depressing as a trigger,
wherein said search and extraction step includes a step of searching the data of the program corresponding to the specific field information based on a keyword, from data of a table of contents and data of program contents both superimposed on the broadcast of the predetermined system,

32. A recording medium, wherein the recording media according to claims 17 to 31 are provided in a system, and each step stored in the media is read by a processing apparatus which performs operation controlling to the system.

33. An information processing apparatus comprising:
reception means for receiving data of a predetermined system including additional data;
extraction means for extracting the additional data from the data received by said reception means;
judgment means for judging whether or not the data extracted by said extraction means is data corresponding to specific field information, by using a keyword; and
output means for outputting the data based on said judgment means and said extraction means.

34. An apparatus according to claim 33, wherein the data of the predetermined system is at least any of television broadcast including data superimposed on a vertical blanking term, television broadcast including data superimposed on a voice sub-carrier, FM broadcast including data superimposed on a radio wave, satellite broadcast including data superimposed on a radio wave, and broadcast transmitted through an internet.

35. An apparatus according to claim 33, wherein the additional data is at least any of data in character broadcast and data in data broadcast.

36. An apparatus according to claim 33, wherein said judgment means judges whether or not the data extracted by said extraction means is the data corresponding to the specific field information, by judging whether or not the keyword concerning the specific field information is included in any of data of a table of contents and data of contents both included in the data extracted by said extraction means.

37. An apparatus according to claim 33, further comprising instruction means for instructing said output means to output the data.

38. An apparatus according to claim 33, further comprising setting means for setting information including the specific field information.

39. An apparatus according to claim 33, further comprising setting means for setting information including an output time of said output means.

40. An apparatus according to claim 38 or 39, wherein said setting means can add and change the setting information.

41. An apparatus according to claim 33, wherein said output means performs a layout process to lay out the additional data extracted by said extraction means on a predetermined output format.

42. An apparatus according to claim 41, wherein said output means print outputs the data subjected to the layout process.

43. An apparatus according to claim 41, wherein said output means display outputs the data subjected to the layout process.

44. An apparatus according to claim 33, wherein said output means outputs the data to an apparatus which performs recording and reproducing on a recording medium.

45. An apparatus according to claim 33, further comprising record and reproduction means for recording onto a recording medium the data received by said reception means together with the additional data included in the received data, and inputting a reproduction signal of the recorded data to said extraction means.

46. An apparatus according to claim 33, wherein each of said means is provided in a printer.

47. An apparatus according to claim 1, wherein the data is described in an HTML (HyperText Markup Language).

48. An apparatus according to claim 15, wherein the data is described in an HTML (HyperText Markup Language).

49. A medium according to claim 17, wherein the data is described in an HTML (HyperText Markup Language).

50. A medium according to claim 31, wherein the data is described in an HTML (HyperText Markup Language).

51. An apparatus according to claim 33, wherein the data is described in an HTML (HyperText Markup Language).
